(19) United States
(12) Patent Application Publication
(10) Pub. No.: US 2026/0077627 A1
(43) Pub. Date: Mar. 19, 2026

(54) Active Suspension System

(71) Applicant: Advanced Suspension Technology LLC, Northville, MI (US)

(72) Inventors: Monzer AL SAKKA, Sint-Truiden (BE); Sebastiaan VAN AALST, St. Truiden (BE); Kylian PRAET, Antwerp (BE)

(21) Appl. No.: 19/328,844

(22) Filed: Sep. 15, 2025

Related U.S. Application Data
(60) Provisional application No. 63/696,437, filed on Sep. 19, 2024.

(51) Int. Cl. B60G 17/0185; B60G 17/08

(52) U.S. Cl. CPC B60G 17/0185; B60G 17/08; B60G 2500/112

(57) ABSTRACT

A suspension system comprises a bidirectional pump including a first port and a second port as well as an actuator including a first working chamber and a second working chamber. A first hydraulic line fluidically interconnects the first port and the first working chamber. A second hydraulic line fluidically interconnects the second port and the second working chamber. A first flow control valve is in fluid communication with the first working chamber. A control valve is positioned in one of the first and second hydraulic lines and closed when the bidirectional pump operates in a failure mode.

### CROSS-REFERENCE TO RELATED APPLICATION

This application claims the benefit of United States Provisional Application No. 63/696,437, filed on September 19, 2024. The entire disclosure of the application referenced above is incorporated herein by reference.

### FIELD

The present disclosure relates to active suspension systems for vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Automotive vehicles include suspension systems to dampen energy inputs that may occur as the vehicle travels across uneven surfaces. Some suspension systems are active systems operable to output a force from an actuator to assist with vehicle ride height, heave, roll and pitch control. Several known active suspension systems use a bi-directional pump. To assure proper function even when components of the system may fail, these systems need to be fail-safe and meet an Automotive Safety Integrity Level (ASIL) B or C. The bi-directional pump may need to comply with ASIL C.

When the pump has failed or is failing, the pump needs to act as high restriction element to provide enough passive force to the actuator. Otherwise, in some layouts, a failed pump may create a short circuit between the rebound and compression chambers of the damper. As a result, insufficient damping forces may be generated at one or more wheel ends to maintain proper operation of the vehicle.

In one arrangement, the electrical phases of the motor can be short-circuited to create some resistance to pump rotation, but this typically works only at high rotational speed of the motor. When the pump speed is low, this concept is inadequate. Several other solutions may exist to modify the design of the pump to make it leakage-free when it fails. These designs, however, cause the pump to be very expensive, and the new features may counteract other features relating to occupant comfort in some systems. Accordingly, there is a need in the art for a simplified solution to compensate for suspension system pump failure.

### SUMMARY

A suspension system comprises a bidirectional pump including a first port and a second port as well as an actuator including a first working chamber and a second working chamber. A first hydraulic line fluidically interconnects the first port and the first working chamber. A second hydraulic line fluidically interconnects the second port and the second working chamber. A first flow control valve is in fluid communication with the first working chamber. A control valve is positioned in one of the first and second hydraulic lines and closed when the bidirectional pump operates in a failure mode.

In another configuration, a suspension system comprises a bidirectional pump including a first port and a second port as well as an actuator including a first working chamber and a second working chamber. A first hydraulic line fluidically interconnects the first port and the first working chamber. A second hydraulic line fluidically interconnects the second port and the second working chamber. A bypass line fluidically interconnects the first hydraulic line and the second hydraulic line. The control valve is positioned in one of the first and second hydraulic lines. A restriction valve is positioned in the bypass line.

### BRIEF DESCRIPTION OF THE DRAWINGS

The present disclosure will become more fully understood from the detailed description and the accompanying drawings, wherein:

FIG. 1 is a schematic depicting an existing prior art hydraulic actuation system;

FIG. 2 is a schematic depicting a hydraulic system constructed in accordance with the teachings of the present disclosure;

FIG. 3 is a schematic depicting the system of FIG. 2 operating in a fail-safe mode of operation;

FIG. 4 is a schematic depicting a suspension system;

FIG. 5 is a schematic depicting the suspension system of FIG. 4 in an active push force mode;

FIG. 6 is a schematic depicting the suspension system of FIG. 4 in an active pull force mode;

FIG. 7 is a schematic depicting the suspension system of FIG. 4 in a fail-safe mode;

FIG. 8 is a schematic depicting an alternate embodiment of a suspension system;

FIG. 9 is a schematic depicting a suspension system of FIG. 8 operating in an active push force mode;

FIG. 10 is a schematic depicting a suspension system of FIG. 8 operating in an active pull force mode; and

FIG. 11 is a schematic depicting a suspension system of FIG. 8 operating in a fail-safe mode.

In the drawings, reference numbers may be reused to identify similar and/or identical elements.

### DETAILED DESCRIPTION

Example embodiments will now be described more fully with reference to the accompanying drawings.

Example embodiments are provided so that this disclosure will be thorough, and fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

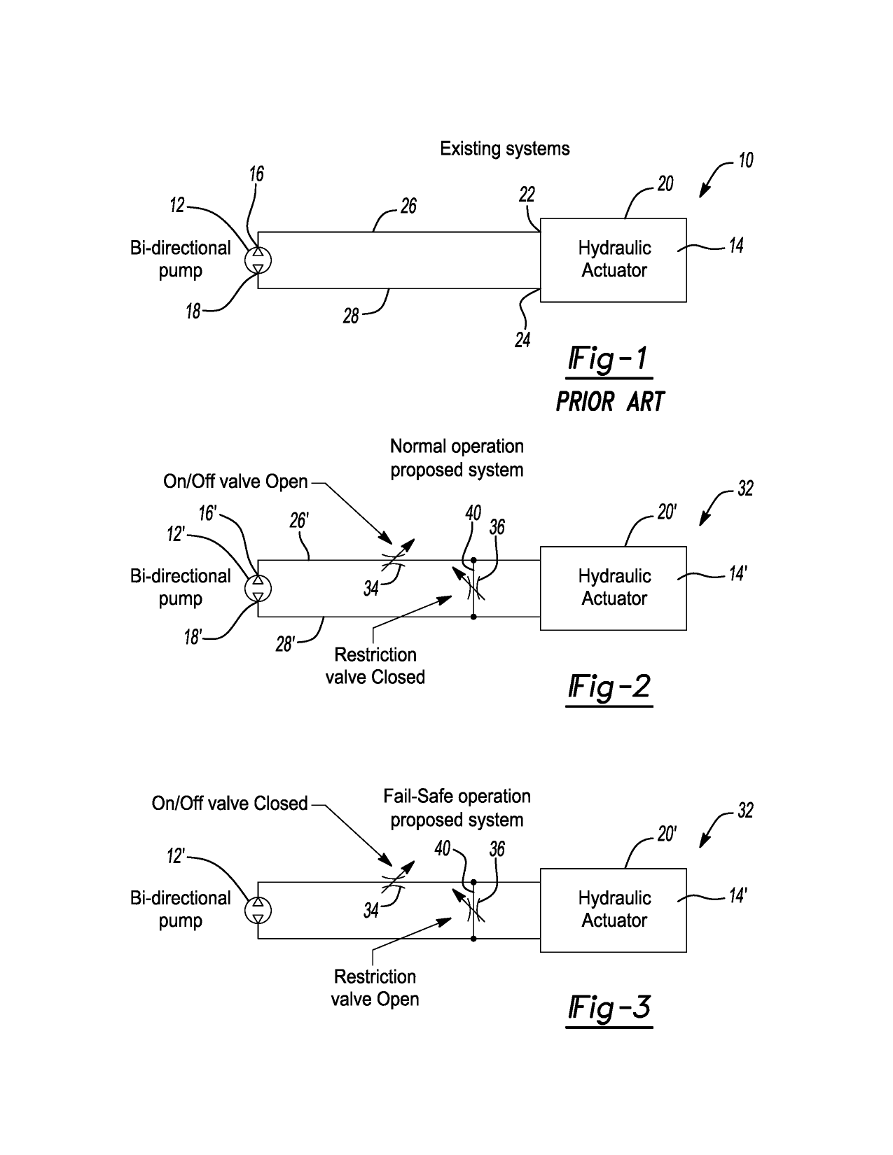

FIG. 1 depicts hydraulic system 10 including a bidirectional pump 12 and a hydraulic actuator 14. Bidirectional pump 12 includes a first port 16 and a second port 18. Hydraulic actuator includes a housing 20 including a first opening 22 and a second opening 24. A first hydraulic line 26 fluidically interconnects first port 16 and first opening 22. A second hydraulic line 28 fluidically interconnects second port 18 and second opening 24. Depending on the rotational direction of the pump, first port 16 is either the inlet or the outlet while second port 18 is the opposite, namely the outlet or the inlet. Hydraulic actuator 14 includes a working member (not shown) upon which the fluid exiting the outlet of the bidirectional pump 12 acts. System 10 is a closed system such that fluid is returned from hydraulic actuator 14 to the inlet of bidirectional pump 12.

As previously noted, if bidirectional pump 12 should fail in a manner such that fluid may easily pass between first port 16 and second port 18, insufficient resistance to movement of the working member of hydraulic actuator 14 may occur. If the pump is part of a system configured as system 10 and implemented in a suspension of a vehicle, this failure mode may be unacceptable.

With reference to FIGS. 2 and 3, Applicant’s proposed solution is represented as a hydraulic system 32. Hydraulic system 32 is substantially similar to hydraulic system 10 with the exception of an additional control valve 34 and a restriction valve 36. As such, like elements will retain their previously introduced reference numerals including a prime suffix. Control valve 34 may be constructed as an on/off valve positioned in first hydraulic line 26’ or in second hydraulic line 28’. Restriction valve 36 is positioned within a bypass line 40 interconnecting first hydraulic line 26’ and second hydraulic line 28’. In normal operation as depicted in FIG. 2, control valve 36’ is open and restriction valve 36 is closed. This valve configuration mimics the flow path found in existing systems as depicted in FIG. 1. Fluid flow is uninterrupted between bidirectional pump 12’ and hydraulic actuator 14’.

FIG. 3 depicts a fail-safe operation mode of hydraulic system 32. In this mode, control valve 34 is closed to account for the lack of internal restriction within bidirectional pump 12’. Restriction valve 36 is operable as a variable flow control valve to selectively restrict flow through bypass line 40, if desired. The magnitude of dampening provided by hydraulic actuator 14’ may be controlled by varying the restriction to flow through restriction valve 36. Restriction valve 36 may be configured as an electrically operated valve having a single orifice or several orifices. Alternatively, the restriction valve 36 may be configured as a check valve or a pressure relief valve. In yet another alternative arrangement, restriction valve 36 may be removed entirely from the hydraulic system as a cost reduction measure. Bypass line 40 may also be removed from the hydraulic system in this configuration. It should be appreciated that in the various modes of operation described within the description, restriction valve 36 being closed provides an identical function to the alternate arrangement suspension system having bypass line 40 and restriction valve 36 removed from the system.

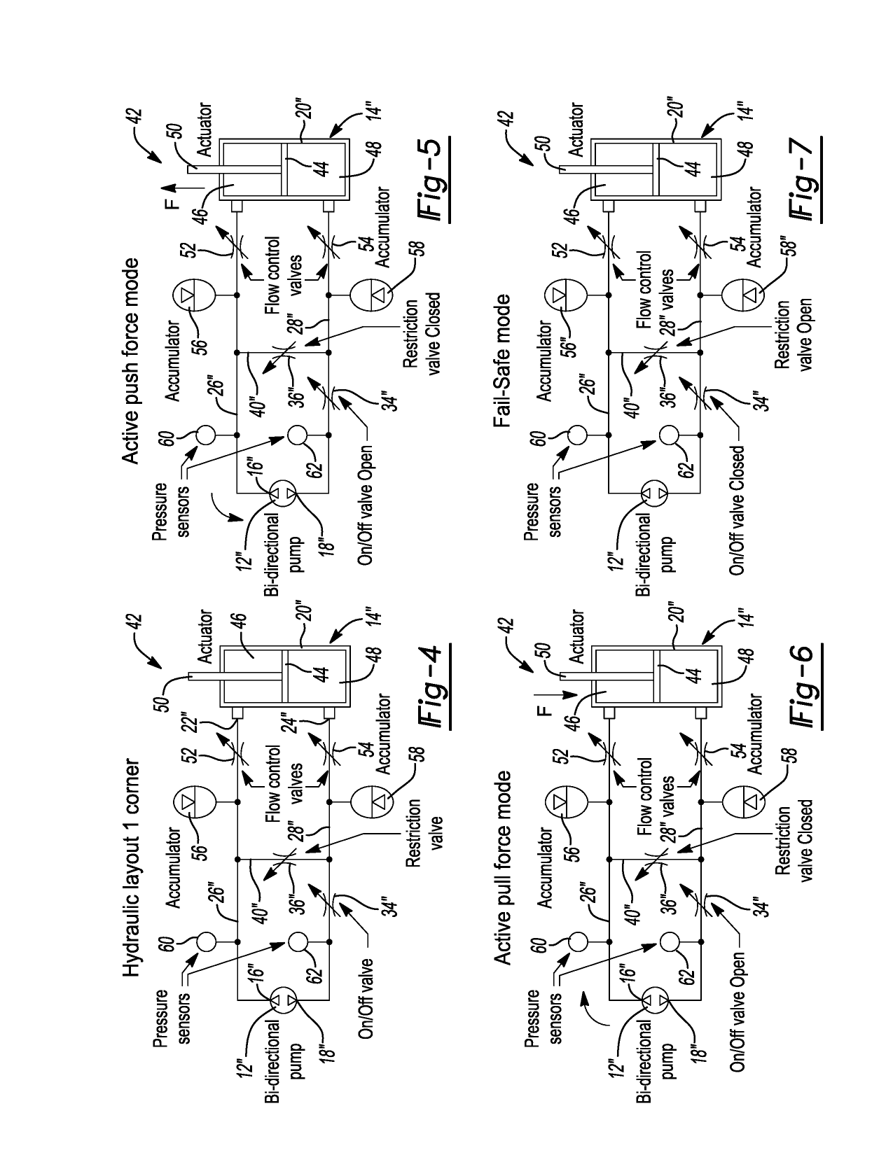

FIGS. 4-7 depict a hydraulic system for one wheel of an exemplary vehicle (not shown). As shown in FIG. 4, a hydraulic suspension system for one corner of a vehicle is identified at reference numeral 42. Suspension system 42 is substantially similar to system 32 previously described and depicted in FIGS. 2 and 3. Accordingly, similar elements will retain their previously introduced reference numerals including a double prime suffix.

Actuator 14” is configured as a damper including a piston 44 positioned within housing 20” to define a first working chamber 46 and a second working chamber 48. A piston rod 50 is coupled to piston 44. A first flow control valve 52 is positioned within first hydraulic line 26”. First control valve 52 is operable to selectively change the flow rate characteristics of the fluid entering and exiting first working chamber 46. Similarly, a second flow control valve 54 is positioned within second hydraulic line 28” to control fluid flow entering and exiting second working chamber 48. A first accumulator 56 is positioned within first hydraulic line 26” at a location between bidirectional pump 12” and first flow control valve 52. A second accumulator 58 is positioned in second hydraulic line 28’ at a location between bidirectional pump 12’ and second flow control valve 54. A first pressure sensor 60 is in fluid communication with hydraulic line 26”. A second pressure sensor 62 is in fluid communication with second hydraulic line 28”.

FIG. 5 depicts suspension system 42 in an active push force mode. In this mode of operation, bidirectional pump 12” outputs pressurized fluid to second port 18”. Control valve 34” is open. Restriction valve 36” is closed. Pressurized fluid enters second working chamber 48 and a force F is applied in the direction of the arrow shown in FIG. 5. The pressurized fluid output by bidirectional pump 12’’ charges first accumulator 56. Fluid exits first working chamber 46, passes through flow control valve 52, and returns to first port 16” of bidirectional pump 12”.

FIG. 6 depicts system 42 operating in active pull force mode where piston rod 50 applies a force F in the direction of the arrow in FIG. 6. Bidirectional pump 12” is operated in the opposite direction as shown in FIG. 5. Accordingly, pressurized fluid exits first port 16” to charge first accumulator 56, pass through first control valve 52 and pressurize first working chamber 46. In the active pull force mode shown in FIG. 6, the control valve 34” is open and restriction valve 36” is closed. Fluid within second working chamber 48 is expelled to pass through second flow control valve 54 and return to second port 18”.

FIG. 7 depicts suspension system 42 operating in a fail-safe mode should bidirectional pump 12” begin to act like a short circuit or open conduit. In this mode of operation, control valve 34” is closed to restrict flow to bidirectional pump 12”. Restriction valve 36” is open to allow fluid flow through bypass line 40”. It should be appreciated that, due to the presence of first accumulator 56” and second accumulator 58”, suspension system 42 may provide an upward force in the direction of force F as shown in FIG. 5 or alternatively in the direction of force F as shown in FIG. 6 by providing pressurized fluid from the second or first accumulators 58, 56, respectively.

With reference to FIGS. 8-11, another alternate hydraulic suspension system is identified at reference numeral 70. Suspension system 70 is substantially similar to suspension system 42. As such, similar elements will retain their previously introduced reference numerals including a triple prime suffix. The most significant difference between suspension system 70 and suspension 42 lies in the use of a single accumulator 72 shown in FIG. 8 as compared to first and second accumulators 56, 58 previously discussed with reference to FIG. 4. Single accumulator 72 is in fluid communication with both first flow control valve 52’’’ and second control valve 54’’’. Flow control valve 52’ is positioned within a first charging line 76 that is fluidically connected to first working chamber 46’’’ and accumulator 72. Second control valve 54’’’ is positioned within a second charging line 78 that fluidically interconnects second working chamber 48’’’ and accumulator 72. The remainder of the connections to actuator 14’’’ are substantially the same as those depicted in FIGS. 2 and 3 with relation to hydraulic system 32. Accordingly, hydraulic system 70 is operated using a combination of principles from hydraulic system 32 and hydraulic system 42.

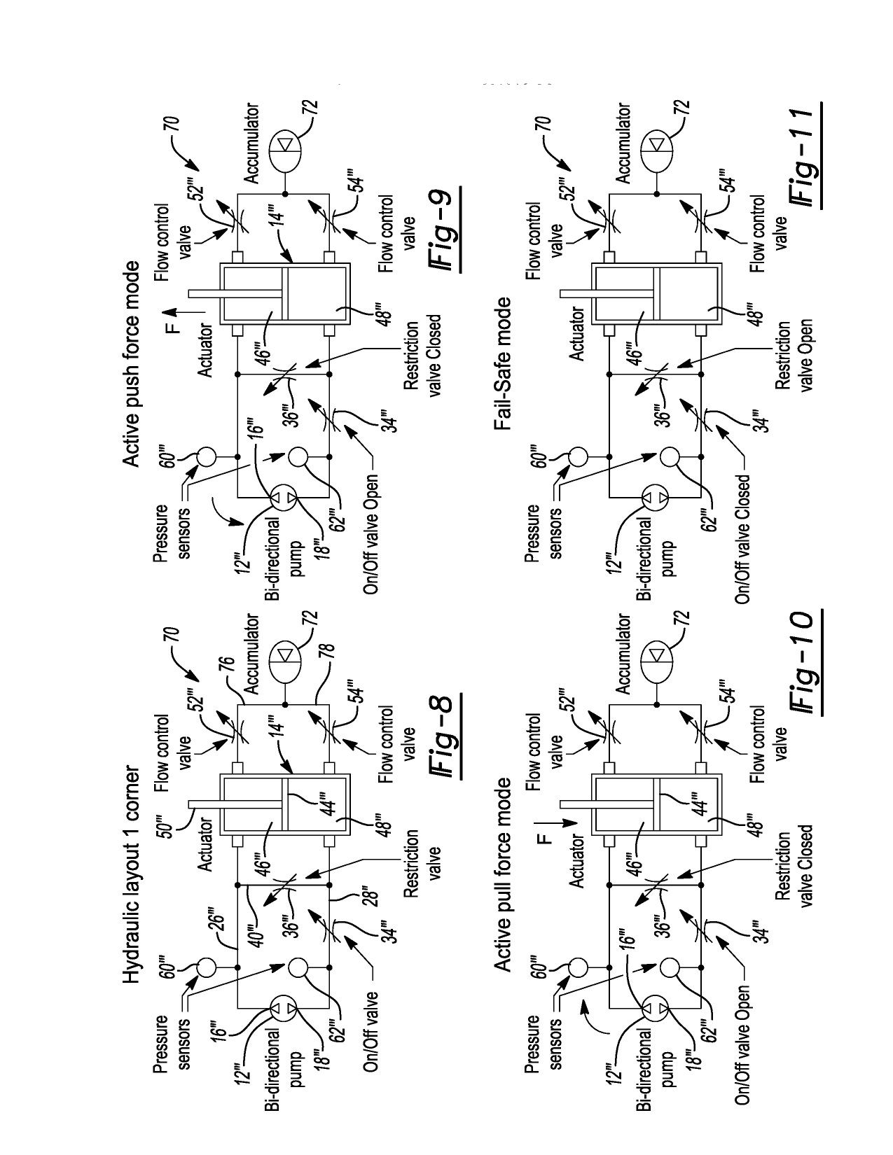

As shown in FIG. 9, hydraulic system 70 may be operated in an active push force mode by rotating bidirectional pump 12’’’ in a direction to output pressurized fluid from second outlet 18’’’. In this mode of operation, control valve 34’’’ is open and restriction valve 36’’’ is closed. A force F is output in the direction of the arrow in FIG. 9. Fluid within first working cavity 46’’’ is returned to first port 16’’’. Accumulator 72 may be charged by the pressurized fluid within second working chamber 48’’’ passing through second control valve 54’’’.

FIG. 10 depicts hydraulic system 70 operating in an active pull force mode. In the active pull force mode shown in FIG. 10, bidirectional pump 12’’’ is operated in the opposite direction as depicted in FIG. 9. Pressurized fluid exits first port 16’’’ and is provided to first working chamber 46’’’ and accumulator 72. In this mode of operation, control valve 34’’’ is open and restriction valve 36’’’ is closed. First control valve 52’’’ and second control valve 54’’’ may be controlled to adjust the damping characteristics of actuator 14’’’.

FIG. 11 depicts hydraulic system 70 operating and a fail-safe mode. In similar fashion to that previously described, fail-safe mode is entered when bidirectional pump 12’’’ acts as a short circuit or provides minimal resistance to flow therethrough. In this mode of operation, control valve 34’’’ is closed to restrict flow through pump 12’’’. Restriction valve 36’’’ is open. System 70 provides damping control to actuator 14’’’ even while operating in a fail-safe mode due to the presence of pressurized fluid within accumulator 72 and the ability to adjust first flow control valve 52’’’ and second control valve 54’’’.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Further areas of applicability of the present disclosure will become apparent from the detailed description, the claims and the drawings. The detailed description and specific examples are intended for purposes of illustration only and are not intended to limit the scope of the disclosure.

What is claimed is:

1. A suspension system comprising:
a bidirectional pump including a first port and a second port;
an actuator including a first working chamber and a second working chamber;
a first hydraulic line fluidically interconnecting the first port and the first working chamber;
a second hydraulic line fluidically interconnecting the second port and the second working chamber;
a first flow control valve in fluid communication with the first working chamber; and
a control valve positioned in one of the first and second hydraulic lines and closed when the bidirectional pump operates in a failure mode.

2. The suspension system of claim 1, further comprising a second flow control valve in fluid communication with the second working chamber.

3. The suspension system of claim 2, further comprising a first accumulator in fluid communication with the first working chamber.

4. The suspension system of claim 3, wherein the first flow control valve is positioned between the first working chamber and the first accumulator.

5. The suspension system of claim 4, further comprising a second accumulator in fluid communication with the second working chamber.

6. The suspension system of claim 5, wherein the second flow control valve is positioned between the second working chamber and the second accumulator.

7. The suspension system of claim 1, further comprising a bypass line fluidically interconnecting the first hydraulic line and the second hydraulic line and a restriction valve positioned in the bypass line.

8. The suspension system of claim 7, wherein the restriction valve is operable to allow fluid flow therethrough when the control valve is closed and vice versa.

9. The suspension system of claim 7, wherein the restriction valve is operable to allow fluid flow therethrough when the bidirectional pump is experiencing a failure mode.

10. The suspension system of claim 1, wherein the second flow control valve is operable to be adjusted to control suspension system damping when the bidirectional pump is experiencing a failure mode.

11. A method of operating a suspension system in a fail-safe mode, comprising:
providing a bidirectional pump including a first port and a second port;
providing an actuator including a first working chamber and a second working chamber;
fluidically interconnecting the first port and the first working chamber with a first hydraulic line;
fluidically interconnecting the second port and the second working chamber with a second hydraulic line;
positioning a control valve in one of the first and second hydraulic lines; and
closing the control valve to restrict fluid flow therethrough based on the bidirectional pump being in a failure mode.

12. The method of claim 11, further comprising providing a first flow control valve in fluid communication with the first working chamber and adjusting fluid flow through the first flow control valve during the failure mode of the bidirectional pump.

13. The method of claim 12, further comprising providing a first accumulator in fluid communication with the first working chamber.

14. The method of claim 11, further comprising providing a bypass line fluidically interconnecting the first hydraulic line and the second hydraulic line and positioning a restriction valve in the bypass line.

15. The method of claim 14, further comprising operating the restriction valve to allow fluid flow therethrough when the control valve is closed and vice versa.

16. The method of claim 14, further comprising operating the restriction valve to allow fluid flow therethrough when the bidirectional pump is in a failure mode.

17. The method of claim 11, wherein the failure mode of the bidirectional pump includes unintentionally allowing fluid to pass through the pump.

18. The method of claim 13, providing a second flow control valve in fluid communication with the second working chamber and adjusting fluid flow through the second flow control valve during the failure mode of the bidirectional pump.

19. The method of claim 18, further comprising providing a second accumulator in fluid communication with the second working chamber.
